(19) United States
(12) Patent Application Publication
(10) Pub. No.: US 2013/0082008 A1
(43) Pub. Date: Apr. 4, 2013

(54) WASTE WATER TREATMENT USING MULTI-STAGED OXIDATION REACTOR

(71) Applicant: Paul Hatten, Carlsbad, CA (US)

(72) Inventor: Paul Hatten, Carlsbad, CA (US)

(21) Appl. No.: 13/621,822

(22) Filed: Sep. 17, 2012

Related U.S. Application Data
(60) Provisional application No. 61/535,292, filed on Sep. 15, 2011.
(60) Provisional application No. 61/613,382, filed on Mar. 20, 2012.

(51) Int. Cl. C02F 1/72

(52) U.S. Cl. CPC C02F 1/72
USPC 210/748.04; 210/758; 210/760; 210/748.01; 210/150

(57) ABSTRACT

Systems, apparatus and methods are described that control and manage wastewater collection and treatment. A method for treating waste water comprises receiving from a vessel, a portion of a body of fluid for treatment at an input port, providing the oxidizing gas under pneumatic or vacuum pressure to a mixing chamber, where the oxidizing gas comprises one or more of oxygen and ozone, and conducting the portion of the fluid to the mixing chamber. The fluid and oxidizing gas may be mixed to obtain treated fluid which may be reintroduced to the vessel.

### CROSS-REFERENCE TO RELATED APPLICATIONS

The present Application claims priority from U.S. Provisional Patent Application No. 61/535,292 that was filed Sep. 15, 2011 and U.S. Provisional Patent Application No. 61/613,382 that was filed Mar. 20, 2012, which applications are hereby incorporated by reference herein for all purposes.

### BACKGROUND OF THE INVENTION

1. Field of the Invention

The present invention relates generally to water treatment systems, more particularly to waste water treatment systems.

2. Description of Related Art

Sewage systems are in wide spread use for the removal of liquid waste from houses, factories and agricultural sites. The sewage flows through pipes into intermediate wells and finally into treatment plants or waste dumps. Electric pumps are usually used to maintain the flow and keep the wells below maximum capacity. These pumps are configured to operate when the level in the wells reaches a preset limit indicating that the flow needs pumping.

Wastewater collection and treatment systems are a source of bad odors, the most prevalent coming from Hydrogen Sulphide, a toxic and corrosive gas with a characteristic rotten-egg smell. This is a bacterially mediated process that occurs in the submerged portion of sanitary sewerage systems. It begins with the establishment of a slime layer below the water level, composed of bacteria and other inert solids held together by a biologically secreted protein “glue” or biofilm called zooglea. When this biofilm becomes thick enough to prevent the diffusion of dissolved oxygen, an anoxic zone develops under the surface.

Hydrogen Sulfide is also a precursor to the formation of Sulfuric Acid, which causes the destruction of metal and concrete substrates and appurtenances within wastewater facilities and collection stations. The effect of biogenic sulfide corrosion and the formation of a 7% Sulfuric Acid solution on concrete surfaces exposed to the sewer environment are devastating. Entire pump stations and manholes and large sections of collection interceptors have collapsed due to the loss of structural integrity in the concrete. Accordingly the residue must be cleaned off the well walls and removed from the surface of the sewer water periodically to maintain the system in good working order as well as protecting concrete structures against the biogenic sulfide corrosion in wastewater collection and treatment systems so as to met the structure's anticipated design life as well as protecting the surrounding ground level infrastructure and environment.

### BRIEF SUMMARY OF THE INVENTION

Certain embodiments of the present invention provide systems and methods for controlling and managing waste water treatment.

Certain embodiments provide a multi-stage water treatment system. The system may comprise one or more oxidation reactor, at least one MBBR and a grinder pump that pressurizes a fluid transmitted through the one or more oxidation reactors and the at least one MBBR. The oxidation reactor may infuse the fluid with an oxidizing gas. The oxidation reactor may comprise an input port that receives a flow of the fluid, a generator that produces a supply of the oxidizing gas, and a mixing chamber, that hydrodynamically mixes the oxidizing gas received from the generator with a portion of the fluid received from the input port. The mixing chamber may produce a treated fluid. The oxidizing gas may comprise one or more of oxygen and ozone.

In some embodiments, the oxidation reactor comprises a vacuum pump adapted to cyclically evacuate the treated fluid from the mixing chamber. The system may comprise a plurality of concatenated oxidation reactors. The system may comprise a plurality of oxidation reactors operating in parallel, each oxidation reactor concurrently processing a portion of fluid provided by a force main or storage vessel.

In some embodiments, the MBBR uses a biological agent to break down organic matter in the fluid. The MBBR may comprise a media reactor tank that houses the biological agent. The one or more oxidation reactors may draw a portion of the fluid from the media reactor tank. The one or more oxidation reactors oxidize a portion of the fluid in the media reactor tank.

### BRIEF DESCRIPTION OF THE DRAWINGS

FIG. 1 is a schematic illustrating a wastewater treatment system according to certain aspects of the invention.

FIG. 2 is a schematic representation of an oxidation reactor according to certain aspects of the invention.

FIG. 3 is a simplified block representation of a processing system according to certain aspects of the invention.

FIG. 4 is a schematic representation of an oxidation reactor according to certain aspects of the invention.

FIG. 5 shows a simplified example of a computing system employed in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention comprise systems, methods and apparatus that resolve environmental problems in municipal, industrial and other applications including H₂S & VOC odor, iron bacteria, grease (FOG) accumulation and so on. For example, certain embodiments can be used to oxidize undesirable chemicals such as sulfides, ammonia and organic solvents, and can kill bio-film growth. Certain embodiments of the invention provide methods for controlling the operation of well cleaning apparatus. In particular, computing systems may be deployed to monitor the environment within water treatment plant, including in wells, forced mains, sewers and other infrastructure used to handle and treat waste water, well water, sewage, storm water, contaminated water, grey water, oil well brines, and other fluids. The fluids may include solid matter.

Certain embodiments of the present invention can be retrofitted to conventional wastewater treatment systems, including well cleaning apparatus and it will be appreciated that certain components of well cleaning equipment may be redesigned, adapted and/or reconfigured to maximize the advantages accrued from the present invention.

### Materials Injection

Certain embodiments may be configured or adapted to deliver chemicals and other additives to the interior of a main, vessel, well, or other element of a waste water treatment system. The materials may include, for example, one or more of a detergent, an oxidizer (such as O₂ or O₃), bleach, calcium nitrate, ferric chloride, magnesium hydroxide, peroxide, milk of magnesia and/or other chemical selected to target and breakdown a material or group of materials. These additives may be introduced for the purpose of oxidizing compounds that can cause odor and corrosion within water treatment systems. Inorganic gases produced from domestic wastewater decomposition commonly include malodorous gases such as hydrogen sulfide and ammonia and odor producing substances including organic vapors such as indoles, skatoles, mercaptans and nitrogen-bearing organics. It will be appreciated that hydrogen sulfide may react with lime in concrete walls of wells and such reaction can cause structural damage. Hydrogen sulfide may also produce sulfuric acid that can attach and corrode metal and other components of wastewater treatment infrastructure. The oxidation process enabled according to certain aspects of the invention can oxidize sulfides, thereby eliminating conditions favorable for anaerobic bacteria to produce H₂S. The oxidation process may provide an oxygen/ozone mix that is a powerful oxidant that inhibits incoming anaerobic bacteria and/or by reducing sulfide levels while increasing DO. Introduction of ozone and oxygen into the force main can augment these effects.

Hydrogen sulfide, whether in a gaseous or an aqueous state, is an example of undesirable compounds commonly associated with waste water. A variety of chemicals, organic compounds and/or bio-augmentation products may be mixed with the wastewater and the combination, quantity and/or timing of introduction of such compounds may be controlled based on storage conditions and a treatment plan. Treatment plans, schedules and rules may be provided to avoid undesired interactions of the additives. Additives may used to enhance breakdown of fat, oil, grease and bio-film. Additives may comprise a detergent, an oxidizer or other chemical selected to target and breakdown a material or group of materials. Additives may also comprise an organism added to effect biological breakdown of materials. As will be appreciated, certain additives may react with or interfere with other additives; hence, different additives may be added at different times, typically to achieve different purposes.

In one example, certain embodiments of the invention pretreat contaminated water that contains various levels of sulfide (H₂S) in aqueous and gaseous state, sulfite, sulfates and carbonaceous biochemical oxygen demand (CBOD). Elemental sulfur may be produced and is typically, flushed from the system. Sulfite and sulfate contaminants are typically oxidized to effect change of the aqueous sulfide ion and subsequent sulfur forms. Certain embodiments of the invention enable improved mixing and mass transfer of additives with contaminated water and the increased contact, including time of contact, can improve oxidation of sulfides and sulfates in contaminated water to produce insoluble free sulfur, thereby eliminating or significantly reducing odors.

In one example, hydrogen sulfide and aqueous sulfide is easily oxidized by ozone to form sulfite. Initial oxidation is to form elemental sulfur. Further oxidation dissolves the elemental sulfur to sulfite and continued ozone oxidation ultimately forms sulfate. More ozone is required to produce sulfate from hydrogen sulfide than is required for sulfur. To achieve this, certain embodiments of the invention employ a process of direct injection of concentrated ozone and/or oxygen gas into a flowing stream of contaminated water.

### Moving Bed Reactor

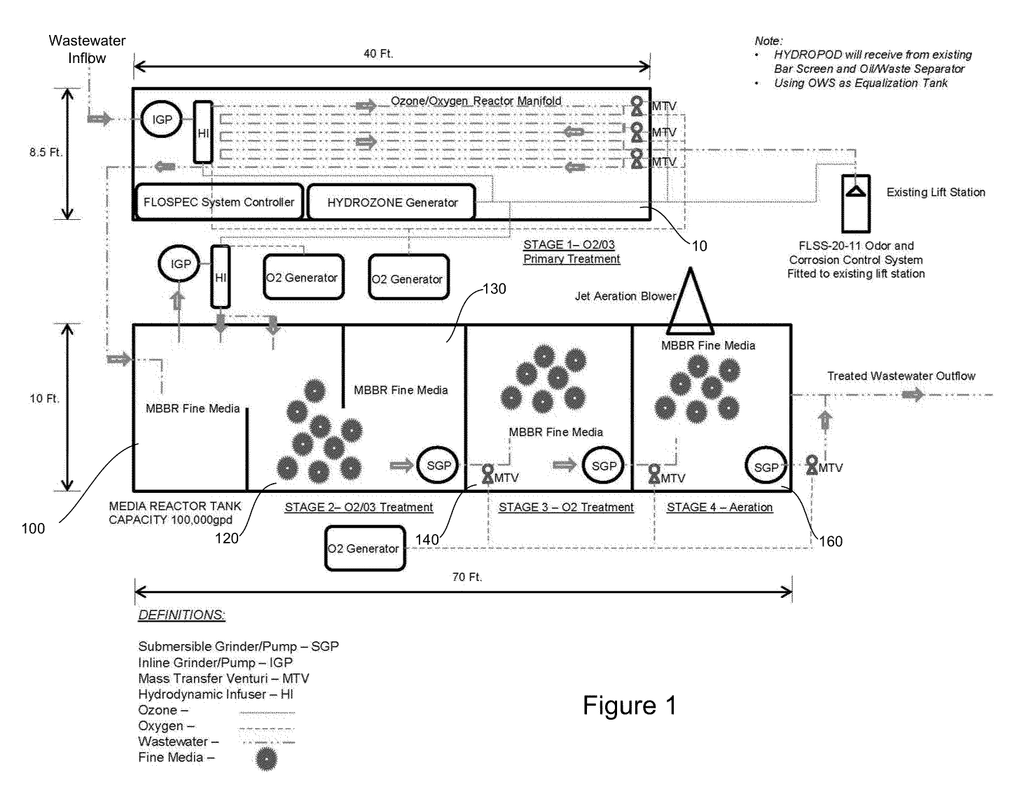

Certain embodiments of the invention comprise systems that receive a wastewater flow, treat the flow in a plurality of stages and produce an outflow of treated wastewater. With reference to FIG. 1, treatment stages may include an oxidation reactor 10 and one or more moving bed bioreactor (“MBBR”) treatment stages 100, 120, 130, 140 and 160. Flow through the system is typically forced by one or more grinder pumps, at least some of which are provided within the body of the MBBR treatment stages 100, 120, 130, 140 and 160.

A wide variety of different types of wastewater may be treated using systems constructed according to certain aspects of the invention. For the purposes of this description, an example is described in which an inflow of wastewater may be received from a bar screen separator and/or an oil/waste separator (“OWS”) or the like. A bar screen can be deployed at the entrance of conventional wastewater treatment plant and are used to remove large objects such as large solid waste materials including rocks, discarded containers, fabrics, and so on, from waste flowing into the treatment plant. An OWS may be used to extract hydrocarbons from the wastewater. Other separators may include vertical gravity separators and fat, oil and grease (FOG) separators.

In certain embodiments, a reactor manifold receives wastewater inflow from an inline grinder/pump. The reactor typically comprises a hydrodynamic infuser that infuses oxygen and/or ozone received from one or more oxygen and/or ozone generators. In certain embodiments, one or more mass transfer venturis may be used to introduce oxygen and/or ozone into the fluid being treated in the reactor.

Operation of the manifold, inline pumps and/or grinders, oxygen generators, and ozone generators may be controlled by a programmable system controller that monitors inflow volume and constituents and controls rate of infusion and introduction of oxygen and/or ozone.

Oxygenated fluids are received by media reactor tank 100 from the reactor 10, from which it flows through MBBR treatment stages 120, 130, 140 and 160. Ozone and/or oxygen may be selectively introduced to the media reactor tank 120 and into one or more of the remaining MBBR treatment stages 120, 130, 140 and 160. In the example depicted, two oxygen/ozone treatment stages are depicted, where the oxygenated fluid is treated using MBBR fine media which acts on organic and other materials in the fluid, typically using biological agents to break down the organic matter. As oxygen content is depleted, more oxygen or ozone can be added as desired. At the final treatment stage 160, a jet aeration blower may be employed in conjunction with MBBR fine media.

In certain embodiments, wastewater may be received from conventional lift stations, forced main systems and from settling tanks, etc. Other fluids may be processed, including brines from oil wells, water from aquifers and from industrial outflows.

### Oxidation Reactor

In certain embodiments, a multi-staged oxidation reactor (MSOR) is employed to augment treatment of contaminated liquid flow. In some embodiments, the treatment system may be employed to provide microbial control. Contaminated liquid is received at an input to the MSOR, which may be fitted inline of a contaminated liquid flow that can be received from an equalizing tank or from a reservoir or piped liquid feed. The MSOR may comprise a pressurized ozonized ultrasonic irradiation oxidation and precipitation process that uses one or more of hydrodynamic mixing, ozone, oxygen for advanced oxidation and acoustic cavitation and electro-oxidation for microbial control.

In some embodiments, ultrasonic acoustic cavitation and/or electro-oxidation may be introduced for an improved saturation effect by causing momentary creation of vacuum “tears” or cavities, which may also be referred to herein in general terms as “bubbles” in a fluid or fluid stream. The fluid may immediately and violently implode to produce millions of microscopic jets of liquid which may gently treat materials in a closed loop system. These tears or cavities may be created tens of thousands of times each second to gently remove contaminants without damage, provided an appropriate ultrasonic frequency is selected for the treatment application. Simultaneous addition of ultrasonic irradiation and ozonized gas may be necessary to degrade more recalcitrant unsaturated products.

In certain embodiments, liquid enters into the closed loop system through a designated and appropriately sized intake pipe. The liquid may be delivered at a predetermined pressure and flow rate via an inline grinder/ripping pump, which may also be employed to initiate multiplication of liquid surface area and/or to prepare the liquid for particle sizing treatment appropriate to stage two of process.

In a second or later stage of the process, the liquid may be permitted to pass through an initial gas-to-liquid infusion process. An inline venturi may allow for initial gas-to-liquid infusion to achieve a desired level of mass transfer. After initial infusion takes place, liquid may be drawn or sucked through the venturi by a pump and subsequently pushed through an inline static mixer allowing for hydrodynamic mixing to occur prior to a third stage of the process that enhances initial mass transfer.

The third stage of the described process may comprise a liquid equalization. Liquid equalization may occur in an oxygen and/or air pressurized batch reactor tank where further dynamic shearing may take place allowing the reactive production of minute bubble size saturated liquid flow for effective advanced oxidation.

In a fourth stage, the liquid flow may be introduced into a multi stage reactor manifold where the liquid flow may undergoes ultrasonic/acoustic cavitation (UCA) causing the momentary creation of vacuum “tears” or “micro-bubbles” in the fluid which can immediately and violently implode to produce millions of microscopic jets of liquid. These tears or cavities may be created tens of thousands of times each second to gently remove organic contaminants. The thermochemical reaction caused by millions of microscopic jets of liquid produces many pathways including highly reactive hydroxyl radicals. Simultaneous addition of ultrasonic acoustic irradiation and certain introduced gases readily reacts with most organic compounds and further degrade the more recalcitrant unsaturated daughter products. Multiple UAC pods may be placed along parts of the reactor manifold to effect vacuum tears.

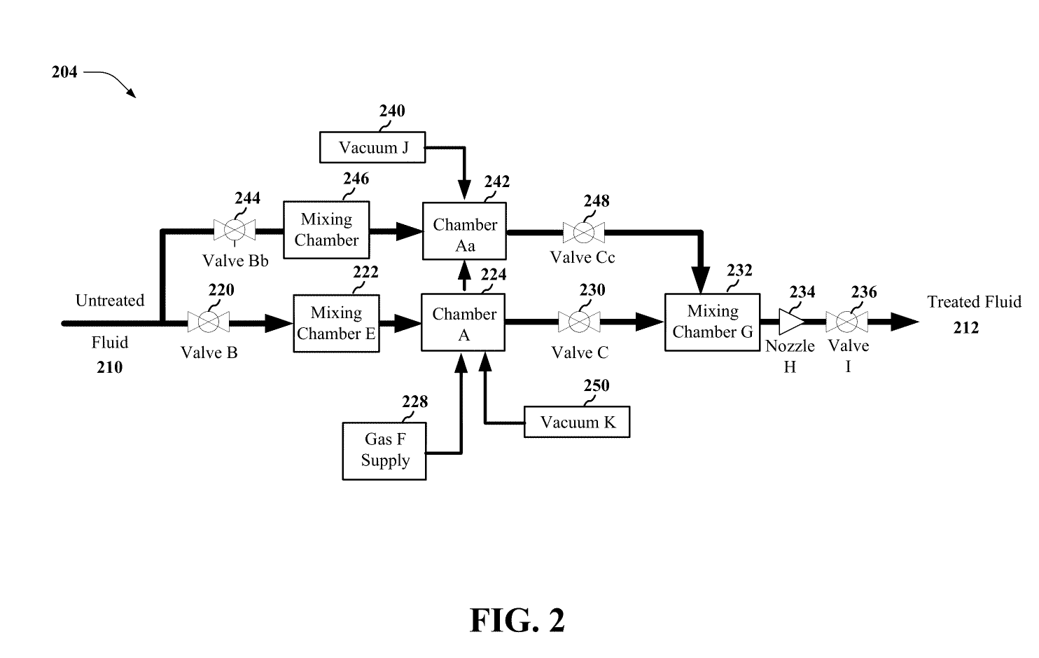

With reference to FIG. 2, a fifth stage of the process may involve introduction of a treated side stream of highly pressurized ozonized ultrasonic acoustic irradiation liquid. A side stream of treated liquid may be diverted through a device 204 that further oxidizes the liquid with a mixture of ozone and oxygen. Ozone is typically 108 times more soluble than oxygen and is a highly reactive oxidant that kills bacteria and oxidizes hydrocarbon bonds and heavy metals etc. In the described process, ozone may be created using nitrogen separators that remove nitrogen and moisture from ambient air producing dry oxygen at high oxygen purity which is then passed through a plasma block high frequency ozone generator and introduced into the enhanced mass transfer module (EMTM).

After oxidation, the liquid, in a controlled flow, may then be reintroduced back into the reactor manifold through additional shearing nozzles. The EMTM may be a pneumatic/vacuum operated alternating multistage gas infusion to unfiltered liquid particle saturation device that is automatically controlled, depending on pressure and flow requirements, creating additional reactions with double bonds also extracting hydrogen atoms from organic compounds.

This device may comprise an additional closed loop system designed to achieve highly enhanced mass transfer of gas to liquid in a multi stage manner into a side stream of liquid from a greater body/volume of liquid flow, in alternating succession over a timed cycle so to achieve regular constant saturation of gas into that liquid, that may then be reintroduced into a greater body/volume of liquid flow at a greater pressure than the existing body/volume of liquid in a way that will affect desired treatment.

A plurality of EMTMs may be fitted to an existing reactor manifold via either one or two mechanically tapped points of varying sizes. The EMTM can be fitted back to back in modular way so to increase the infusion treatment process within a shorter time period and based on calculations of pre-existing contaminates, daily liquid flow (volume), liquid temperature and inline liquid pressure.

Operation of EMTM 204 may comprise closing a chamber 224 to atmosphere via actuated valve 220 and actuated valve 230 and then filling chamber 224 with a gas mixture at a desired pressure. Once chamber 224 is filled valve 230 is opened to allow the flow of liquid from existing fluid filled pipe, at existing pressure, to pass through the mechanically tapped point inlet port of the device into hydrodynamic mixing chamber 222 then into chamber 224 mixing with the existing gas present in chamber 224 until chamber 224 is filled to the point whereby it can no longer overcome existing pressure of gas present in chamber 224. At this pressure valve 220 is then closed to seal chamber 224. Once actuated valve 220 is closed compressed gas 228 flow (oxygen or air) is forced into chamber 224 at a greater pressure than existing pressure in chamber 224 until a pressure higher than the existing fluid filled pipe is achieved. Once higher pressure is achieved via compressed gas 228 flow, compressed gas 228 flow stops actuated valve 230 is opened. Chamber 224 is evacuated and purged of saturated liquid. The saturated liquid under pressure is forced into hydrodynamic mixing chamber 232 then through shearing nozzle 234 through non return valve 236 and then through a mechanically tapped outlet port into the existing fluid filled pipe.

During operation of the EMTM, actuated valve 230 is closed after chamber 224 is evacuated, thereby creating a sealed chamber. Vacuum pump 240 opens and evacuates excess residual pressurized atmosphere into chamber 242, during which time treatment gas is fed under low pressure into vacuum pump venturi, creating a draw of gas via a vacuum along with excess pressurized atmosphere of chamber 224 into chamber 242 until specified volume of treatment gas and specified volume and pressure of compressed gas has been delivered into chamber 242. Once treatment gas volume and pressure is met then vacuum pump 240 may be closed.

During operation of EMTM, chamber 242 is closed to atmosphere via actuated valve 244 and actuated valve 248 is closed. Chamber 242 is then filled with a treatment gas mixture at a desired pressure. Once chamber 242 is filled, valve 244 is opened to allow the flow of liquid from existing fluid filled pipe, at existing pressure, to pass through a mechanically tapped point inlet port of the device into hydrodynamic mixing chamber 246 then into chamber 242 mixing with the existing gas present in chamber 242 until chamber 242 is filled to the point where by it can no longer overcome existing pressure of gas present in chamber 242. At this pressure Valve 244 is then closed to seal chamber 242. Once actuated valve 244 is closed a compressed gas flow (oxygen or air) is forced into chamber 242 at a greater pressure than existing pressure in chamber 242 until a pressure higher than the existing fluid filled pipe is achieved. Once higher pressure is achieved via the compressed gas flow, compressed gas flow stops actuated valve 248 is opened. Chamber 242 is evacuated and purged of saturated liquid. Said saturated liquid under pressure is forced into hydrodynamic mixing chamber 232 then through shearing nozzle 234, through non return valve I and then through a mechanically tapped outlet port into the existing fluid filled pipe.

During operation stage of EMTM, when chamber 242 is evacuated, actuated valve 248 is closed creating a sealed chamber vacuum pump 250 opens and evacuates excess residual pressurized atmosphere into chamber 224 during which time treatment gas is fed under low pressure into vacuum pump 250 venturi, creating a draw of gas via a vacuum along with excess pressurized atmosphere of chamber 242 into chamber 224 until specified volume of treatment gas and specified volume and pressure of compressed gas has been delivered into chamber 224. Once treatment gas volume and pressure is met then vacuum pump 250 is closed.

This four stage cycle may be repeated for the full duration of treatment process over prescribed time frame. In certain embodiments, pneumatic and valve operations are controlled via a programmable logic controller (PLC).

In some embodiments, the reactor manifolds may be combined again into either a secondary manifold or single larger diameter chamber multi staged electro-oxidation reactor which further precipitates salts into nano-sized suspended particles assisting in further oxidization of organic compounds.

In some embodiments, the treated liquid may pass through a final gas to liquid infusion process via an inline venturi allowing for gas to liquid or liquid to liquid infusion achieving a level of mass transfer. Once the final infusion takes place the treated liquid is then drawn or sucked through by a pump and then pushed through an inline static mixer allowing for final hydrodynamic mixing to occur.

In certain embodiments, the entire MSOR comprises a closed loop system that may be operated automatically via a programmed PLC. It receives data to establish operation and control conditions that then can determine operational parameters as is associated with the environment it is treating.

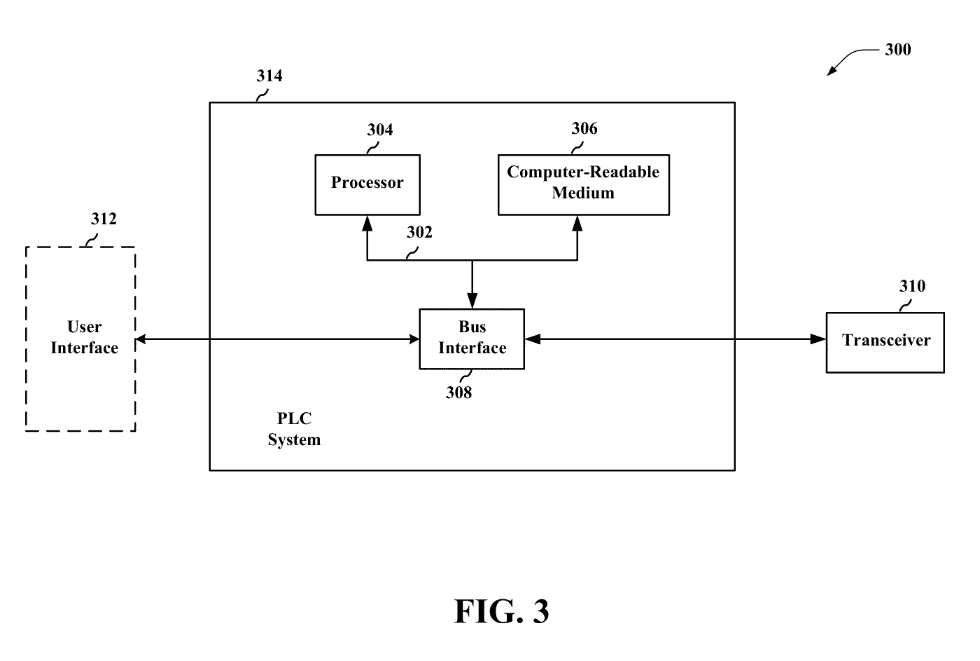

FIG. 3 is a conceptual diagram illustrating an example of a hardware implementation for an apparatus 300 employing a processing system 314 such as PLC device. In this example, the processing system 314 may be implemented with a bus architecture, represented generally by the bus 302. The bus 302 may include any number of interconnecting buses and bridges depending on the specific application of the processing system 314 and the overall design constraints. The bus 302 links together various circuits including one or more processors, represented generally by the processor 304, and computer-readable media, represented generally by the computer-readable medium 306. The bus 302 may also link various other circuits such as timing sources, peripherals, voltage regulators, and power management circuits, which are well known in the art, and therefore, will not be described any further. A bus interface 308 provides an interface between the bus 302 and a transceiver 310. The transceiver 310 provides a means for communicating with various other apparatus over a transmission medium. Depending upon the nature of the apparatus, a user interface 312 (e.g., keypad, display, speaker, microphone, joystick) may also be provided.

The processor 304 is responsible for managing the bus 302 and general processing, including the execution of software stored on the computer-readable medium 306. The software, when executed by the processor 304, causes the processing system 314 to perform the various functions described infra for any particular apparatus. The computer-readable medium 306 may also be used for storing data that is manipulated by the processor 304 when executing software.

Certain aspects of the present Application relate to systems and methods for gas infusion to an unfiltered liquid particle saturation device. In certain embodiments, a gas infusion device may be operated pneumatically or by force of vacuum. In certain embodiments, the device operates as an alternating multistage side stream gas infusion device. A closed loop system may infuse gas into a liquid in multiple stages. The gas, gasses, and/or other fluids may be infused into a side stream of liquid diverted or extracted from a greater body of liquid flow, where the side stream may comprise a relatively small fraction of the total volume of liquid to be treated. The side stream may be drawn from a main, feed pipe, pressure vessel, etc. in alternating succession over a timed cycle so to achieve regular constant saturation of gas into the side stream liquid. The side stream liquid may then be reintroduced into a greater body of liquid flow, and the treated side stream may be pressurized to a greater pressure than the pressure of the main body of liquid. Accordingly, the returned side stream fluid is mixed with the main body fluid and extends treatment to the main body.

### EXAMPLE

### Wastewater Treatment

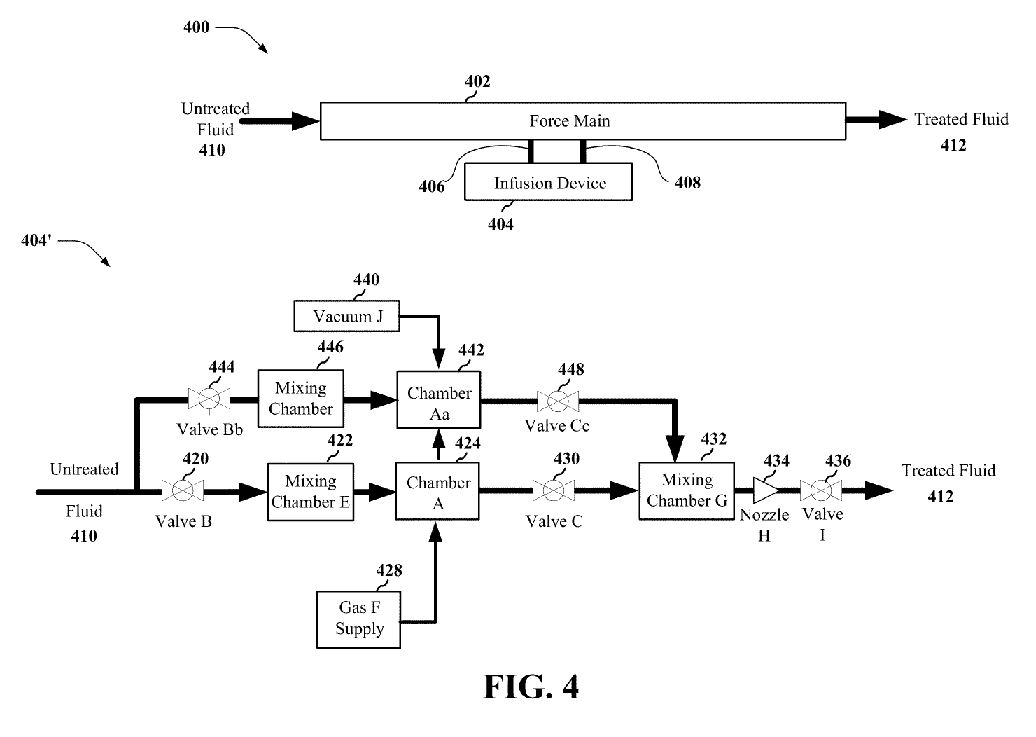

As depicted in the example of FIG. 4, an infusion device 404 may be mounted in proximity to a pipe 402 carrying a fluid to be treated. In one example, pipe 402 may be a force main carrying wastewater. The infusion device 404 may be coupled to the pipe by one or more mechanically taps 406, 408. The taps 406, 408 may be sized as appropriate for the application. The infusion device 404 can be fitted back to back in modular way so to increase the infusion treatment process within a shorter time period.

The diffusion device 404 is depicted in block schematic form generally at 404′. In certain embodiments, a first stage comprises a chamber A 424, which is closed to atmosphere by an actuated valve B 420 and actuated valve C 430. Chamber A 424 is filled with a gas mixture at a desired pressure. After chamber A 424 is filled, Valve B 420 is opened to allow the flow of liquid 410 from a fluid filled pipe 402 to pass through the mechanically tapped point inlet port 406 into hydrodynamic mixing chamber E 422. The flow of liquid may be derived from a pressurized system and may therefore have a pressure that is greater than atmospheric pressure. The flow of liquid may then be introduced into chamber A 424, where it is mixed with the gas mixture present in chamber A 424. When pressure equalization occurs, such that chamber A 424 is filled to the point where the inflow cannot overcome the pressure of the fluid in chamber A 424, Valve B 420 is closed to seal chamber A 424.

Next, compressed gas F 428 may be provided, where Gas F 428 may comprise oxygen and/or air, for example. Gas F 428 is forced into Chamber A 424 at a greater pressure than the inflow pressure (i.e. the pressure achieved when valve B 420 was closed). The introduction of compressed gas F 428 increases pressure in Chamber A 424 until a predefined pressure is achieved, or pressure equalization occurs. Flow of compressed gas F 428 may be stopped, by flow control apparatus or through pressure equalization, and valve C 430 is opened to enable evacuation of the treated fluid from Chamber A 424, which may comprise a saturated liquid. The saturated liquid may be forced into hydrodynamic mixing chamber G 432, and from there through shearing nozzle H 434, through non return valve I 436, and through mechanically tapped outlet port 408 into the fluid filled pipe 402.

In certain embodiments, a second stage includes closing valve C 430 when Chamber A 424 is evacuated, thereby creating a sealed chamber and vacuum pump J 440 may then be activated to evacuate excess residual pressurized atmosphere into chamber Aa 442. Treatment gas 428 may be simultaneously fed under low pressure into a venturi of vacuum pump J 440, creating a draw of gas by vacuum along with excess pressurized atmosphere of chamber A 424 into chamber Aa 442 until a specified volume of treatment gas and/or specified volume and pressure of compressed gas has been delivered into chamber Aa 442. When treatment gas volume and pressure reach a predefined threshold, then vacuum pump J 440 may be closed.

In certain embodiments, a third stage includes actuating Valve Bb in order to close chamber Aa to atmosphere while valve Cc is closed. Chamber Aa may then be filled with a treatment gas mixture at a desired pressure. When chamber Aa is filled and/or pressurized, valve Bb 444 may be opened to allow a flow of liquid from fluid filled pipe 402, which is typically pressurized to an operating pressure, to pass through the mechanically tapped point inlet port 406 of the device into a hydrodynamic mixing chamber 446. From chamber 446, the flow may be provided into chamber Aa 442, where it is mixed with the gas present in chamber Aa 442. When chamber Aa 442 is filled, such that pressure equalization occurs with regard to the operating pressure of the fluid flow, valve Bb 444 may be closed to seal chamber Aa 442. When valve Bb 444 is closed, compressed gas 428 flow, comprising oxygen and/or air, for example, may be forced into chamber Aa 442 at a greater pressure than the equalized pressure in chamber Aa 442 until a desired higher pressure is achieved. When the desired higher pressure is achieved, typically using a compressed gas 428 flow, compressed gas 428 flow stops actuated valve 448 is opened. Chamber Aa 442 is evacuated and purged of saturated liquid. Said saturated liquid under pressure is forced into hydrodynamic mixing chamber G 432 then through shearing nozzle 434, through non return valve I 436 and then through mechanically tapped outlet port 408 into the fluid filled pipe 402.

In certain embodiments a fourth stage comprises closing a valve Cc 448 when chamber Aa 442 is evacuated, thereby creating a sealed chamber. A vacuum pump K (not shown) may be activated to evacuate excess residual pressurized atmosphere into chamber A 424 during which time treatment gas is fed under low pressure into vacuum pump K venture, thereby creating a draw of gas by means of the vacuum along with excess pressurized atmosphere of chamber Aa 442 into chamber A 424, until a desired or predetermined volume of treatment gas and/or a desired or predetermined volume and pressure of compressed gas have been delivered into chamber A 424. When treatment gas volume and pressure have achieved appropriate levels, then vacuum pump K is closed.

This four stage cycle maybe repeated for the full duration of treatment process over prescribed time frame. In some embodiments, valves, vacuum pumps and other pneumatic components may be controlled using a processor, programmable logic controller (PLC), or the like. In certain embodiments, the treatment process may be effected with the addition of a dedicated liquid pump. The system may be employed with wastewater, grey water and other fluids containing particles that have a size of up to at least 50 mm.

Certain embodiments provide systems and methods for treating water in a force main. Some embodiments comprise conducting a portion of untreated fluid from a main into a first chamber. Some embodiments comprise sealing the first chamber. Some embodiments comprise infusing a treatment gas into the fluid in the first chamber under force of pressure of the treatment gas. Some embodiments comprise returning the fluid from the first chamber to the main.

In some embodiments, returning the fluid includes pressurizing the fluid in the first chamber. In some embodiments, the fluid is pressurized using compressed nitrogen. In some embodiments, the fluid is pressurized using compressed air. Some embodiments comprise mixing the fluid with the treatment gas in a second chamber. In some embodiments, the second chamber comprises a hydrodynamic mixing chamber. In some embodiments, the treatment gas comprises oxygen. In some embodiments, the treatment gas comprises ozone. In some embodiments, the treatment gas comprises air.

Certain embodiments of the invention comprise a treatment that includes a concatenated set of treatment devices. Concatenation may be employed to accommodate differences in flow rate of the fluid to be treated and the treatment gases. In one example, an ozone treatment stage may be unable to treat a volume of water passing through a main at a high rate of flow because the ozone generator produces a limited maximum flow of treatment gas. By concatenating multiple ozone treatment stages, the cumulative production of ozone or other gas may be better matched to the flow of fluid to be treated. In another example, a treatment gas may react relatively slowly and/or hydrodynamic, ultrasonic and/or chemical processes may require a longer timeframe than allowed by the flow rate of the fluid to be treated. Some embodiments can effectively increase the length of the treatment zone by concatenation. In some embodiments, treatment devices can be arranged in parallel to provide effectively a wider pipe that allows a slower flow rate through the treatment zone.

### System Description

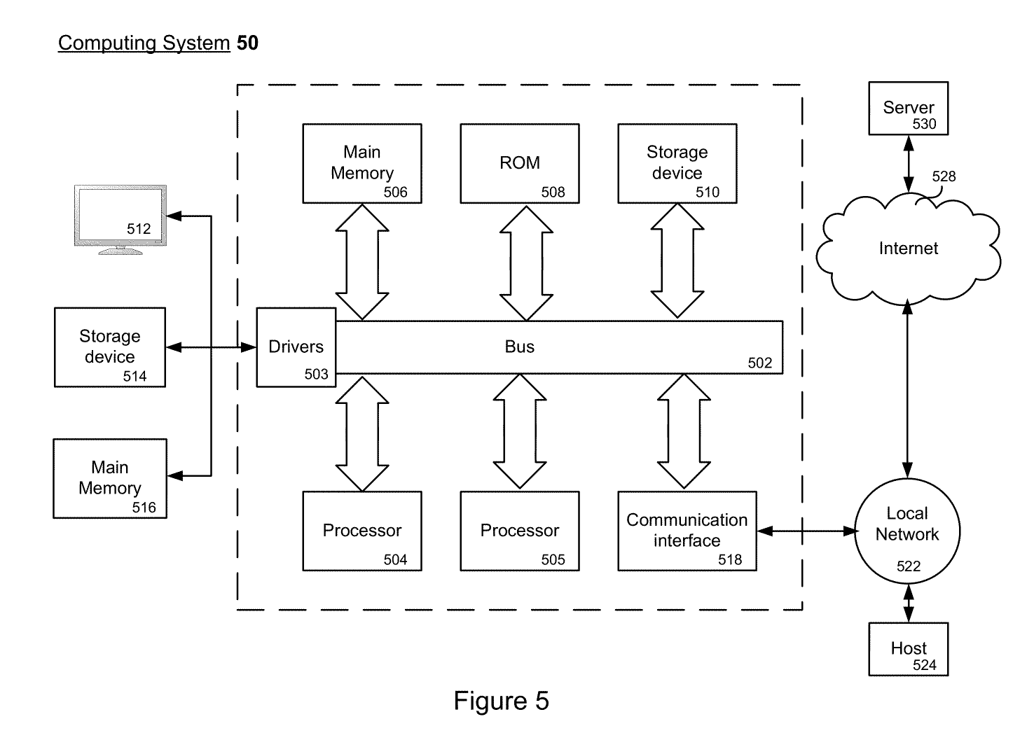

Turning now to FIG. 5, certain embodiments of the invention employ a processing system that includes at least one computing system 500 deployed to perform certain of the steps described above. Computing systems may be a commercially available system that executes commercially available operating systems such as Microsoft Windows®, UNIX or a variant thereof, Linux, a real time operating system and or a proprietary operating system. The architecture of the computing system may be adapted, configured and/or designed for integration in the processing system, for embedding in one or more of an image capture system, a manufacturing/machining system, a graphics processing workstation and/or a . . . In one example, computing system 500 comprises a bus 502 and/or other mechanisms for communicating between processors, whether those processors are integral to the computing system 50 (e.g. 504, 505) or located in different, perhaps physically separated computing systems 500. Device drivers 503 may provide output signals used to control internal and external components

Computing system 500 also typically comprises memory 506 that may include one or more of random access memory (“RAM”), static memory, cache, flash memory and any other suitable type of storage device that can be coupled to bus 502. Memory 506 can be used for storing instructions and data that can cause one or more of processors 504 and 505 to perform a desired process. Main memory 506 may be used for storing transient and/or temporary data such as variables and intermediate information generated and/or used during execution of the instructions by processor 504 or 505. Computing system 500 also typically comprises non-volatile storage such as read only memory (“ROM”) 508, flash memory, memory cards or the like; non-volatile storage may be connected to the bus 502, but may equally be connected using a high-speed universal serial bus (USB), Firewire or other such bus that is coupled to bus 502. Non-volatile storage can be used for storing configuration, and other information, including instructions executed by processors 504 and/or 505. Non-volatile storage may also include mass storage device 510, such as a magnetic disk, optical disk, flash disk that may be directly or indirectly coupled to bus 502 and used for storing instructions to be executed by processors 504 and/or 505, as well as other information.

Computing system 500 may provide an output for a display system 512, such as an LCD flat panel display, including touch panel displays, electroluminescent display, plasma display, cathode ray tube or other display device that can be configured and adapted to receive and display information to a user of computing system 500. Typically, device drivers 503 can include a display driver, graphics adapter and/or other modules that maintain a digital representation of a display and convert the digital representation to a signal for driving a display system 512. Display system 512 may also include logic and software to generate a display from a signal provided by system 500. In that regard, display 512 may be provided as a remote terminal or in a session on a different computing system 500. An input device 514 is generally provided locally or through a remote system and typically provides for alphanumeric input as well as cursor control 516 input, such as a mouse, a trackball, etc. It will be appreciated that input and output can be provided to a wireless device such as a PDA, a tablet computer or other system suitable equipped to display the images and provide user input.

According to one embodiment of the invention, processor 504 executes one or more sequences of instructions. For example, such instructions may be stored in main memory 506, having been received from a computer-readable medium such as storage device 510. Execution of the sequences of instructions contained in main memory 506 causes processor 504 to perform process steps according to certain aspects of the invention. In certain embodiments, functionality may be provided by embedded computing systems that perform specific functions wherein the embedded systems employ a customized combination of hardware and software to perform a set of predefined tasks. One example is a controller used to manage a water treatment system, and may comprise one or more PLC devices. Thus, embodiments of the invention are not limited to any specific combination of hardware circuitry and software.

The term “computer-readable medium” is used to define any medium that can store and provide instructions and other data to processor 504 and/or 505, particularly where the instructions are to be executed by processor 504 and/or 505 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 504 and 505 or remotely, typically by use of network connection. Non-volatile storage may be removable from computing system 504, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 500. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 504 and/or 505. For example, the instructions may initially be retrieved from a magnetic disk of a remote computer and transmitted over a network or modem to computing system 500. The instructions may optionally be stored in a different storage or a different part of storage prior to or during execution.

Computing system 500 may include a communication interface 518 that provides two-way data communication over a network 520 that can include a local network 522, a wide area network or some combination of the two. For example, an integrated services digital network (ISDN) may used in combination with a local area network (LAN). In another example, a LAN may include a wireless link. Network link 520 typically provides data communication through one or more networks to other data devices. For example, network link 520 may provide a connection through local network 522 to a host computer 524 or to a wide are network such as the Internet 528. Local network 522 and Internet 528 may both use electrical, electromagnetic or optical signals that carry digital data streams.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide water treatment systems and methods. Certain of these embodiments comprise a collection station having a well for collecting a body of waste water received from an inflow main. Certain embodiments comprise an ozone generator configured to generate ozone. In some embodiments, the ozone is maintained in a reservoir of ozone.

Certain embodiments comprise a method for treating waste water. In some embodiments, the method comprises receiving from a vessel, a portion of a body of fluid for treatment at an input port. In some embodiments, the method comprises providing the oxidizing gas under pneumatic or vacuum pressure to a mixing chamber. In some embodiments, the method the oxidizing gas comprises one or more of oxygen and ozone. In some embodiments, the method comprises conducting the portion of the fluid to the mixing chamber. In some embodiments, the method comprises causing the fluid and oxidizing gas to be mixed to obtain treated fluid. In some embodiments, the method comprises reintroducing the treated fluid to the vessel.

In some embodiments, the method the vessel comprises a force main. In some embodiments, the method the vessel comprises a storage tank. In some embodiments, the method providing the oxidizing gas comprises generating a supply of ozone.

In some embodiments, causing the fluid and oxidizing gas to be mixed includes causing hydrodynamic agitation of the fluid and oxidizing gas. Causing the fluid and oxidizing gas to be mixed may include agitating the fluid and oxidizing gas using an ultrasonic transducer to produce ultrasonic acoustic cavitation. The ultrasonic acoustic cavitation may create a plurality of vacuum tears in the fluid and oxidizing. In some embodiments, causing the fluid and oxidizing gas to be mixed may include creating a plurality of vacuum tears in the fluid using electro-oxidation.

In some embodiments, the steps of providing the oxidizing gas and causing the fluid and oxidizing gas to be mixed may be repeated one or more times prior to reintroducing the treated fluid to the vessel. Repetition of the steps of providing the oxidizing gas and causing the fluid and oxidizing gas to be mixed may be performed using a plurality of mixing chambers.

Certain embodiments provide a multi-stage water treatment system. The system may comprise one or more oxidation reactor, at least one MBBR and a grinder pump that pressurizes a fluid transmitted through the one or more oxidation reactors and the at least one MBBR. The oxidation reactor may infuse the fluid with an oxidizing gas. The oxidation reactor may comprise an input port that receives a flow of the fluid, a generator that produces a supply of the oxidizing gas, and a mixing chamber, that hydrodynamically mixes the oxidizing gas received from the generator with a portion of the fluid received from the input port. The mixing chamber may produce a treated fluid. The oxidizing gas may comprise one or more of oxygen and ozone.

In some embodiments, the oxidation reactor comprises a vacuum pump adapted to cyclically evacuate the treated fluid from the mixing chamber. The system may comprise a plurality of concatenated oxidation reactors. The system may comprise a plurality of oxidation reactors operating in parallel, each oxidation reactor concurrently processing a portion of fluid provided by a force main or storage vessel.

In some embodiments, an oxidation reactor may comprise an electro-oxidation element that creates vacuum tears in the fluid. In some embodiments, an oxidation reactor may comprise an ultrasonic transducer that creates vacuum tears in the fluid.

In some embodiments, the MBBR uses a biological agent to break down organic matter in the fluid. The MBBR may comprise a media reactor tank that houses the biological agent. The one or more oxidation reactors may draw a portion of the fluid from the media reactor tank. The one or more oxidation reactors oxidize a portion of the fluid in the media reactor tank.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method for treating waste water, comprising:
receiving from a vessel, a portion of a body of fluid for treatment at an input port;
providing the oxidizing gas under pneumatic or vacuum pressure to a mixing chamber, the oxidizing gas comprising one or more of oxygen and ozone;
conducting the portion of the fluid to the mixing chamber;
causing the fluid and oxidizing gas to be mixed to obtain treated fluid; and
reintroducing the treated fluid to the vessel.

2. The method of claim 1, wherein the vessel comprises a force main.

3. The method of claim 1, wherein the vessel comprises a storage tank.

4. The method of claim 1, wherein providing the oxidizing gas comprises generating a supply of ozone.

5. The method of claim 1, wherein causing the fluid and oxidizing gas to be mixed includes causing hydrodynamic agitation of the fluid and oxidizing gas.

6. The method of claim 1, wherein causing the fluid and oxidizing gas to be mixed includes agitating the fluid and oxidizing gas using an ultrasonic transducer to produce ultrasonic acoustic cavitation.

7. The method of claim 6, wherein the ultrasonic acoustic cavitation creates a plurality of vacuum tears in the fluid and oxidizing.

8. The method of claim 1, further comprising creating a plurality of vacuum tears in the fluid using electro-oxidation.

9. The method of claim 1, wherein the steps of providing the oxidizing gas and causing the fluid and oxidizing gas to be mixed are repeated one or more times prior to reintroducing the treated fluid to the vessel.

10. The method of claim 9, wherein repetition of the steps of providing the oxidizing gas and causing the fluid and oxidizing gas to be mixed is performed using a plurality of mixing chambers.

11. A multi-stage water treatment system comprising:
one or more oxidation reactor;
at least one moving bed bioreactor (“MBBR”); and
a grinder pump that pressurizes a fluid transmitted through the one or more oxidation reactors and the at least one MBBR,
wherein at least one oxidation reactor infuses the fluid with an oxidizing gas.

12. The multi-stage water treatment system of claim 11, wherein the at least one of the one or more oxidation reactors comprises:
an input port that receives a flow of the fluid;
a generator that produces a supply of the oxidizing gas; and
a mixing chamber, that hydrodynamically mixes the oxidizing gas received from the generator and a portion of the fluid received from the input port to produce a treated fluid;
wherein the oxidizing gas comprises one or more of oxygen and ozone.

13. The multi-stage water treatment system of claim 12, wherein the at least one oxidation reactor comprises a vacuum pump adapted to cyclically evacuate the treated fluid from the mixing chamber.

14. The multi-stage water treatment system of claim 12, wherein the at least one oxidation reactor comprises a plurality of concatenated oxidation reactors.

15. The multi-stage water treatment system of claim 12, wherein the at least one oxidation reactor comprises a plurality of oxidation reactors operating in parallel, each oxidation reactor concurrently processing a portion of fluid provided by a force main or storage vessel.

16. The multi-stage water treatment system of claim 12, wherein the at least one oxidation reactor comprises an electro-oxidation element or an ultrasonic transducer that creates vacuum tears in the fluid.

17. The multi-stage water treatment system of claim 11, wherein the MBBR uses a biological agent to break down organic matter in the fluid.

18. The multi-stage water treatment system of claim 17, wherein the MBBR comprises a media reactor tank that houses the biological agent.

19. The multi-stage water treatment system of claim 18, wherein the one or more oxidation reactor draws a portion of the fluid from the media reactor tank.

20. The multi-stage water treatment system of claim 19, wherein the one or more oxidation reactor oxidizes a portion of the fluid in the media reactor tank.
